(19) United States
(12) Patent Application Publication
(10) Pub. No.: US 2024/0413626 A1
(43) Pub. Date: Dec. 12, 2024

(54) SNAP-IN FASTENERS FOR ELONGATED MEMBERS

(71) Applicants: Ted G Brull, Parkville, MO (US); Richard G Brull, North Kansas City, MO (US); Dale J Crook, Overland Park, KS (US)

(72) Inventors: Ted G Brull, Parkville, MO (US); Richard G Brull, North Kansas City, MO (US); Dale J Crook, Overland Park, KS (US)

(21) Appl. No.: 18/611,222

(22) Filed: Mar. 20, 2024

Related U.S. Application Data
(60) Provisional application No. 63/453,232, filed on Mar. 20, 2023.

(51) Int. Cl. H02G 3/32

(52) U.S. Cl. CPC H02G 3/32

(57) ABSTRACT

A snap-in fastener for organizing and securing electrical wiring and other elongated members. The snap-in faster includes a clip head attached to a base via a neck. These elements allow the snap-in fastener to be inserted into a mounting rail and manually turned, thereby locking the snap-in fasteners into place. Once in place, the cable, wires, or other elongated members are secured within a cable channel of the clip head

### CROSS-REFERENCE TO RELATED APPLICATION

This application claims priority in U.S. Provisional Patent Application No. 63/453,232 Filed Mar. 20, 2023, which is incorporated herein by reference.

### BACKGROUND OF THE INVENTION

### 1. Field of the Invention

The present invention relates generally to construction, and in particular to snap-in fasteners for wiring and other elongated members.

### 2. Description of the Related Art

Commercial, residential, industrial, and institutional construction components generally include wiring, plumbing and other elongated members. For example, multi-conductor wiring is commonly used for electrical power distribution within structures. Electrical service commonly enters structures at an electrical panel, which can include suitable circuit breaker and fuse protection. From the primary electrical panel wiring is run to various electrical components, such as outlets, switches, and fixtures.

Electrical construction is governed by building codes and regulations. Electrical system construction is commonly inspected before a structure is approved as code-compliant and occupancy is authorized.

In residential construction, electrical distribution panels are commonly mounted on plywood panels attached to concrete foundation and basement walls. However, plywood is susceptible to water damage and rot, particularly over extended periods of time. Electrical codes typically require electrical wiring to be fastened and secured to structural elements, such as framing.

Heretofore there has not been available a snap-in fastener system for electrical cables and other elongated members with the advantages and features of the present invention.

### BRIEF SUMMARY OF THE INVENTION

A snap-in fastener for organizing and securing electrical wiring and other elongated members. The snap-in faster includes a clip head attached to a base via a neck. These elements allow the snap-in fastener to be inserted into a mounting rail and manually turned, thereby locking the snap-in fasteners into place. Once in place, the cable, wires, or other elongated members are secured within a cable channel of the clip head.

The clip head can be modified to include multiple channels for multiple cables and wires.

The clip head may include a tooth within the cable channel to secure and prevent accidental removal of the cables and wires from the cable channel once secured within.

### BRIEF DESCRIPTION OF THE DRAWINGS

The drawings constitute a part of this specification and include exemplary embodiments of the present invention illustrating various objects and features thereof.

FIG. 1 is a front-elevational view of a typical environment of a wall panel box including a preferred embodiment of the present invention.

FIG. 2 is a three-dimensional isometric view of the embodiment snap-in fastener of the present invention thereof shown interfacing with a mounting rail element thereof.

FIG. 3 is a top plan view thereof showing the preferred embodiment snap-in fastener at a first, unlocked orientation with respect to the mounting rail element thereof.

FIG. 4 is a top plan view thereof showing the preferred embodiment snap-in fastener at a second, locked orientation with respect to the mounting rail element thereof.

FIG. 5 is a top plan view of a plurality of the preferred embodiment snap-in fasteners mounting wires to the mounting rail element.

FIG. 6 is a three-dimensional isometric view of the preferred embodiment snap-in member fastener thereof.

FIG. 7 is another three-dimensional isometric view thereof.

FIG. 8 is a front elevational view thereof.

FIG. 9 is a left-side elevational view thereof.

FIG. 10 is a right-side elevational view thereof.

FIG. 11 is a three-dimensional isometric view of an alternative embodiment of the present invention snap-in fastener.

FIG. 12 is a three-dimensional isometric view of yet another alternative embodiment of the present invention snap-in fastener.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Said terminology will include the words specifically mentioned, derivatives thereof and words of similar meaning.

### II. Preferred Embodiment Snap-In Fastener Clip System 2

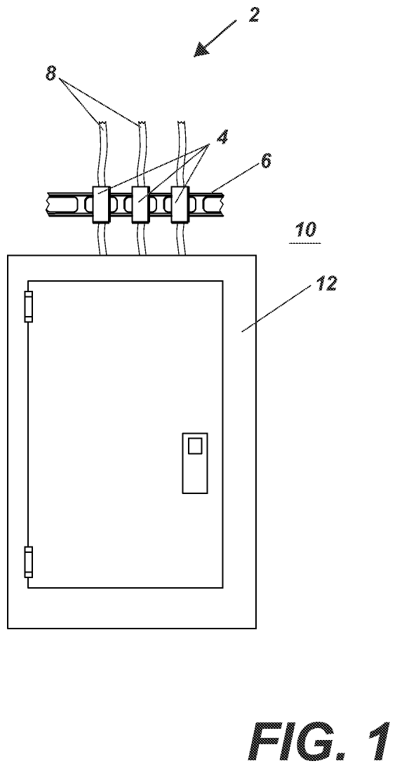

Without limitation on the generality of useful applications of the present invention, FIG. 1 shows a typical environment for the installation of the snap-in fastener clip system 2 embodying the present invention. A typical environment includes a panel box 12 mounting to a wall 10, which panel box receives a main incoming electrical service line 8 as well as multiple branch lines, which extend from the panel box to electrical devices throughout a building.

A mounting rail 6 is anchored to the wall 10. In a typical environment, this mounting rail 6 may be a length of metal channel anchored to a concrete basement foundation wall where the panel box 12 is mounted. The metal channel can comprise a Unistrut® channel, of the type commonly used in construction projects.

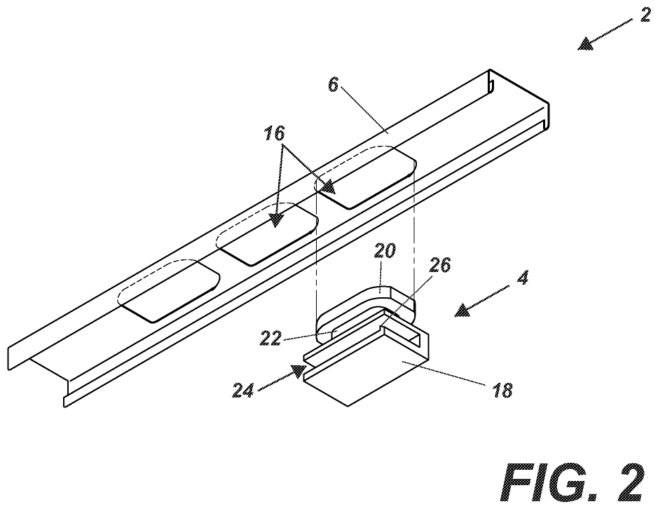

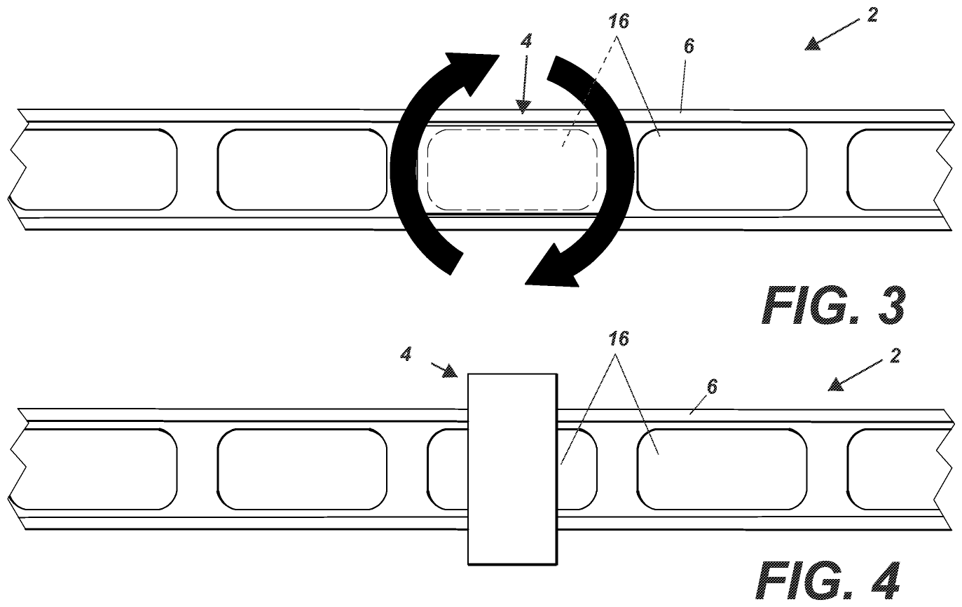

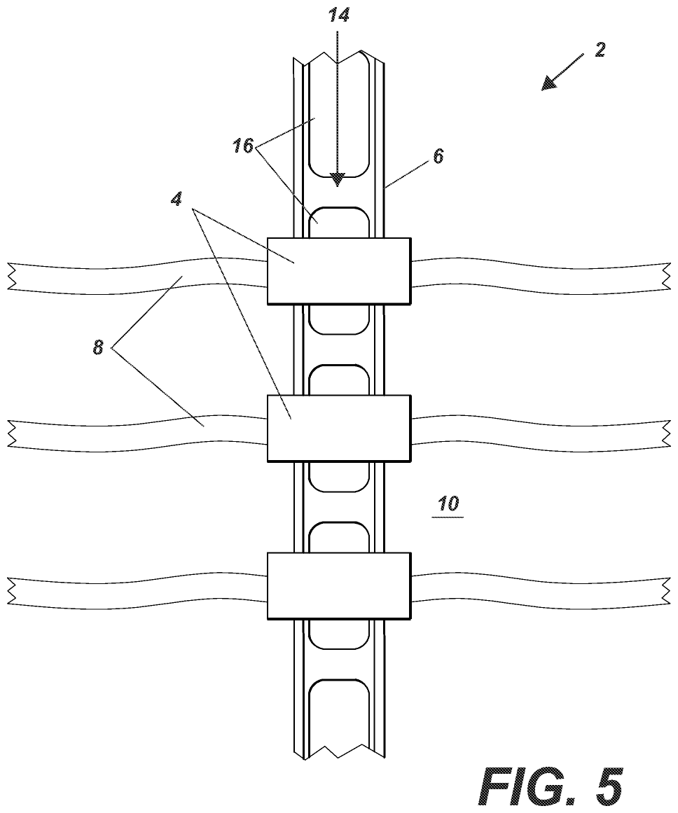

As shown in more detail in FIG. 2, snap-in fasteners 4 are slotted into the mounting rail and secured by rotating them within a mounting slot 16 as shown in FIG. 3, resulting in a locked orientation as shown in FIG. 4. These snap-in fasteners can be mounted by inserting their rounded-corner bases 20 into the receiver holes 16 of the mounting rail and twisting them. The clips can be configured for mounting one or more electrical cables 8 and are scalable to accommodate cables of different sizes (gauges).

The snap-in fastener includes a clip head 18 which is joined to the base 20 via a neck 22 which is sized to lock against the receiver holes 16 when the fastener is rotated as shown in FIG. 3. A cable channel 24 is formed between a first 28 and second 30 bridge formed within the clip head 18. This channel 24 allows the cables 8 to be secured within the fastener 4. A tooth 26 located at the opening end of the channel 24 ensures the cables 8 are not accidentally pulled out.

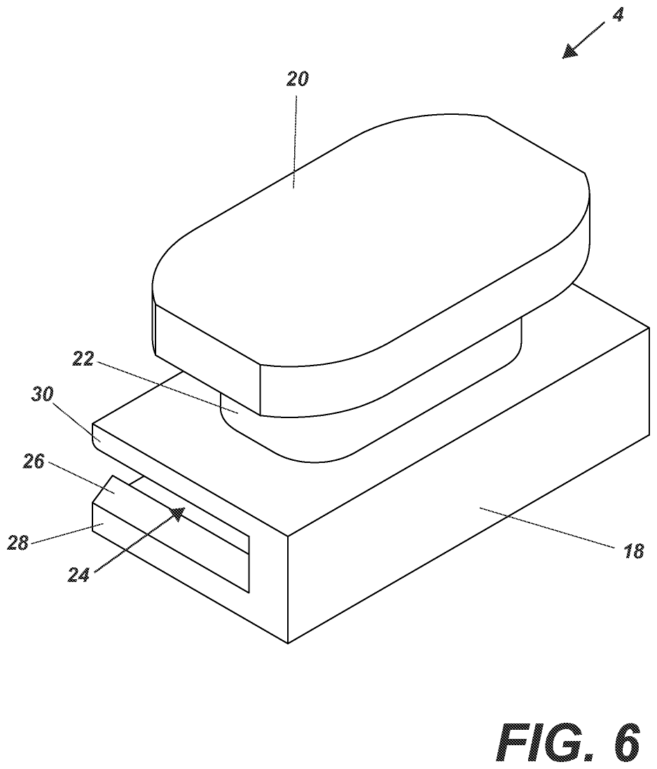

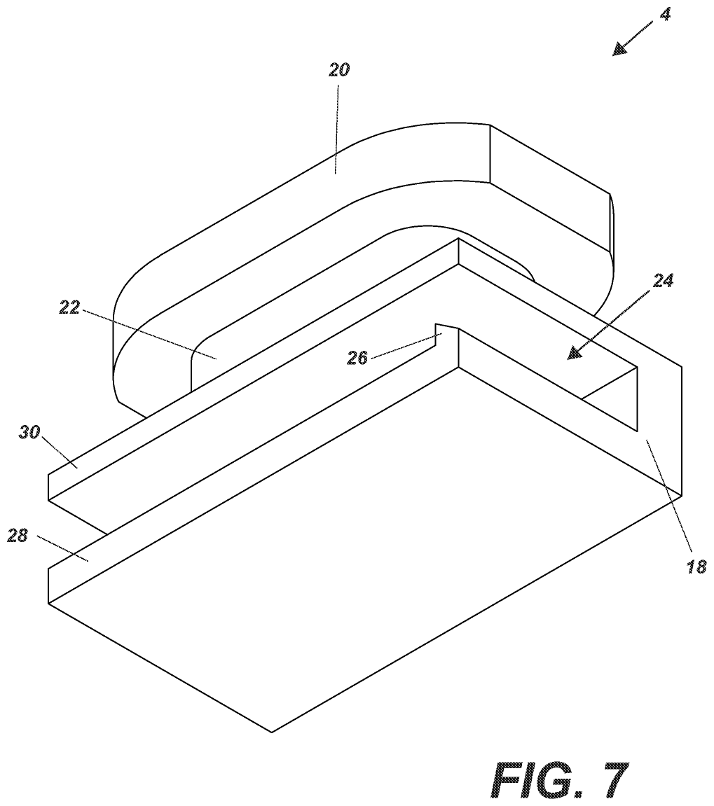

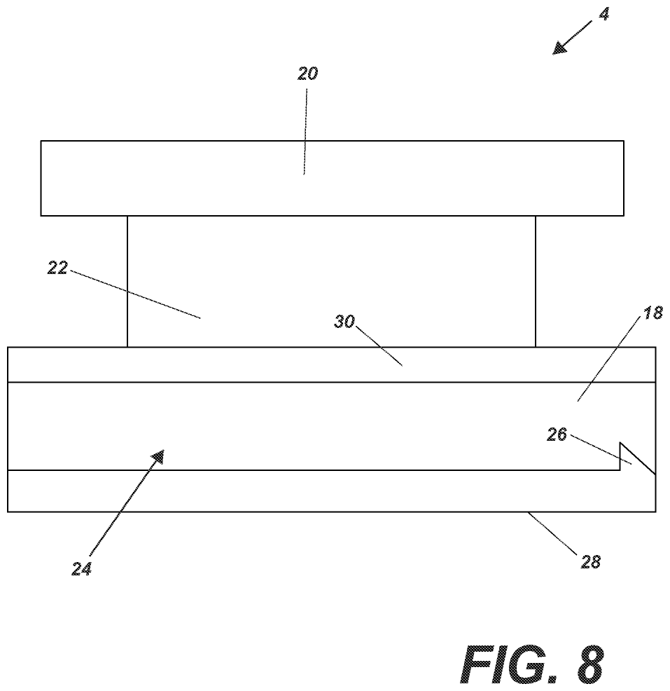

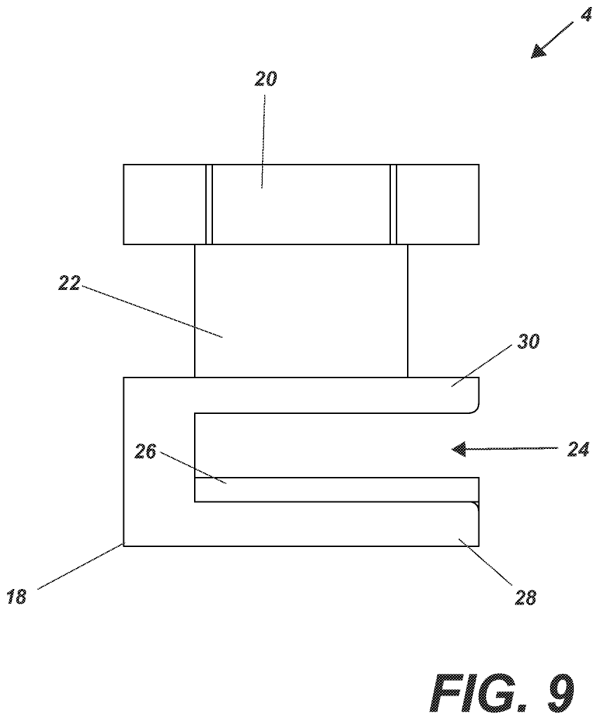

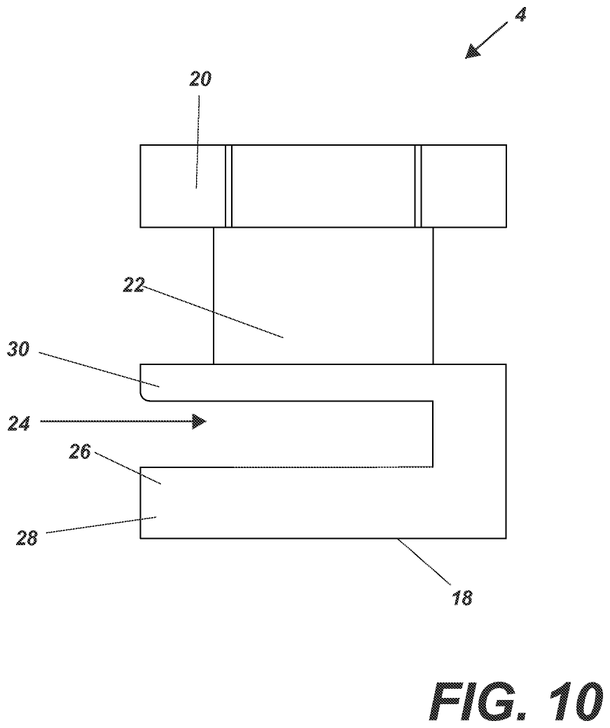

FIGS. 6-10 show this embodiment snap-in fastener 4 in more detail.

### III. Alternative Embodiment Snap-In Fastener 104

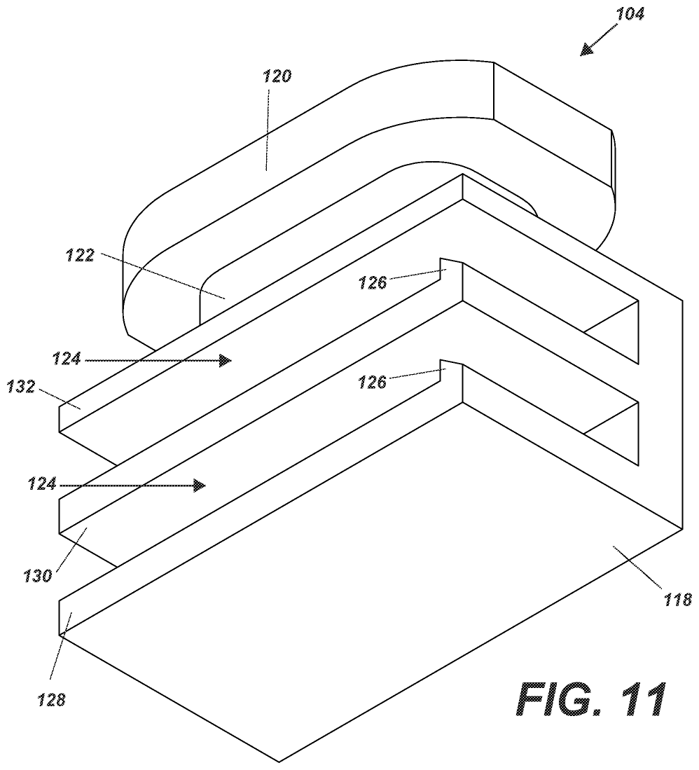

FIG. 11 shows an alternative embodiment snap-in fastener 104 which includes two cable channels 124 formed between first 128, second 130, and third 132 bridges as part of a modified clip head 118 of the snap-in fastener 104. The base 120 and neck 122 remain identical to the previous embodiment base 20 and neck 22. The tooth 126 of this embodiment could also be identical to the tooth 26 of the previous embodiment

### IV. Alternative Embodiment Snap-In Fastener 204

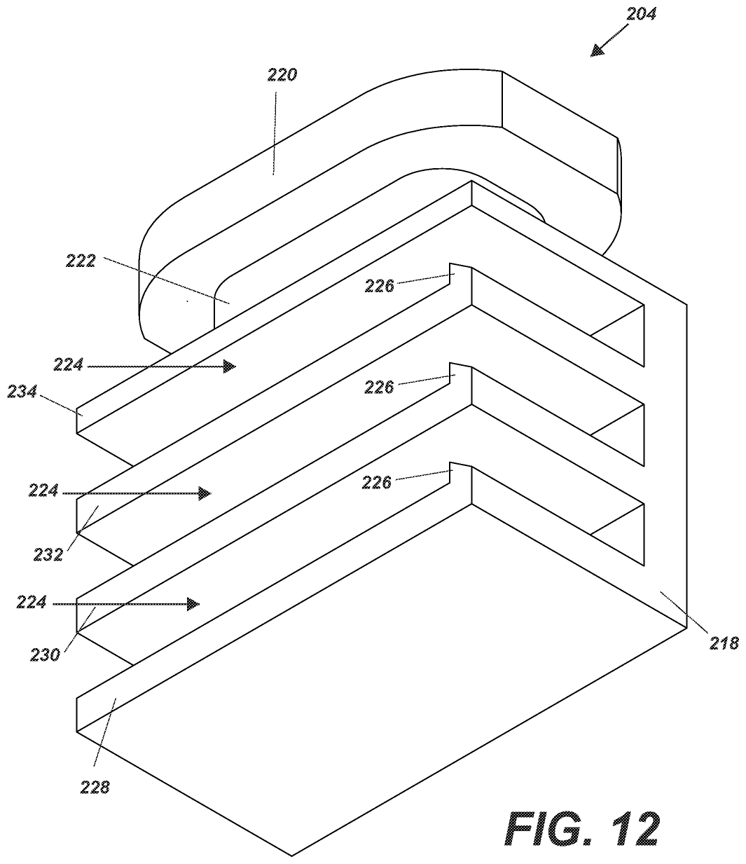

Similarly, FIG. 12 shows another alternative embodiment snap-in fastener 204 which includes three cable channels 224 formed between first 228, second 230, third 232, and fourth 234 bridges as part of a further modified clip head 218 of the snap-in fastener 204. The base 220 and neck 222 remain identical to the previous embodiments bases 20, 120 and necks 22, 122. The tooth 226 of this embodiment could also be identical to the tooths 26, 1236 of the previous embodiments. Any suitable number of cable channels 224 and associated bridges 228, 230, 234, 238 could be used to form additional cable channels for more wires and cables.

These snap-in fasteners 4, 104, 204 can be easily and quickly installed by hand without tools.

The resulting construction complies with building codes and eliminates the need for backer panels, which are commonly made of plywood, particle board, similar materials. Such wood-product panels tend to be susceptible to rot and moisture damage.

Other elongated members can be mounted with the system of the present invention. For example, plumbing supply pipes, fiber optics, pneumatic tubes and other elongated members can be accommodated. The mounting clip system is scalable to accommodate various diameters and gauges of electrical lines and other elongated members.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A snap-in fastener comprising:
a clip head comprising a first bridge and a second bridge cantilevered away from said clip head, said first bridge and said second bridge forming a cable channel therebetween;
said cable channel configured to receive an elongated member;
a base connected to said clip head via a neck, whereby a thickness of said neck is less than a thickness of said base;
said base configured to be slotted into a receiver, whereby said base, neck, and clip head are further configured to be rotated ninety degrees, thereby locking said neck against said receiver and thereby resisting further rotation thereof; and
whereby said elongated member is stored within said cable channel of said clip head.

2. The snap-in fastener of claim 1, wherein at least one of said first and second bridges comprising a tooth configured to retain said elongated member within said cable channel.

3. The snap-in fastener of claim 1, further comprising a third bridge defining a second cable channel between said second bridge and said third bridge.

4. The snap-in fastener of claim 1, wherein said receiver is deposed within a mounting rail comprising additional, ideally-identical receivers.

5. The snap-in fastener of claim 1, wherein said elongated member is selected from a list of elongated members comprising: cables; wires; pipes; and conduits.

6. A power system organization and securing system, the system comprising:
an electrical panel box;
at least one elongated member being connected to said electrical panel box;
a receiver located in proximity to said electrical panel box;
said receiver configured to receive a base of a snap-in fastener, said snap-in fastener further comprising a neck connecting said base to a clip head;
wherein said base, said neck, and said clip head are configured to be manually rotated 90 degrees after said base has been inserted through said receiver, whereby said snap-in fastener is selectively locked into place;
said clip head comprising a first bridge and a second bridge cantilevered away from said clip head, said first bridge and said second bridge forming a cable channel therebetween;
said cable channel configured to receive said at least one elongated member; and
whereby said elongated member is stored within said cable channel of said clip head.

7. The system of claim 6, wherein at least one of said first and second bridges comprising a tooth configured to retain said elongated member within said cable channel.

8. The system of claim 6, further comprising a third bridge defining a second cable channel between said second bridge and said third bridge.

9. The system of claim 6, wherein said receiver is deposed within a mounting rail comprising additional, ideally-identical receivers.

10. The system of claim 6, wherein said elongated member is selected from a list of elongated members comprising: cables; wires; pipes; and conduits.
